(19) United States
(12) Patent Application Publication
(10) Pub. No.: US 2026/0051770 A1
(43) Pub. Date: Feb. 19, 2026

(54) MOTOR STATOR

(71) Applicant: HYUNDAI MOBIS CO., LTD., Seoul (KR)

(72) Inventors: Chang Sup BYEON, Yongin-si (KR); Sang Jin KIM, Yongin-si (KR); Goon Chul KIM, Yongin-si (KR); Hae Jun YANG, Yongin-si (KR); Hwang Yong CHOI, Yongin-si (KR)

(73) Assignee: HYUNDAI MOBIS CO., LTD., Seoul (KR)

(21) Appl. No.: 19/237,511

(22) Filed: Jun. 13, 2025

(30) Foreign Application Priority Data
Aug. 16, 2024 (KR) 10-2024-0109706

(51) Int. Cl. H02K 1/16

(52) U.S. Cl. CPC H02K 1/165

(57) ABSTRACT

The present invention relates to a motor stator, and more particularly, to a motor stator that facilitates the insertion and fixation of coil conductors. The motor stator of the present invention improves NVH characteristics and reduces costs compared to the prior art by eliminating the need for a wedge through the application of a shoe structure integrally formed at the end of an open slot and pressed inward only during hairpin insertion, which not only facilitates the insertion of conductors, including continuous hairpin conductors, but also limits their displacement and movement; moreover, by segmenting the stator into multiple sections along the axial direction, with some sections applying the shoe structure and others not, it can be configured to meet desired specifications while considering electromagnetic efficiency, conductor displacement force, and ease of insertion.

### CROSS REFERENCE TO RELATED APPLICATION

The present application claims priority to Korean Patent Application No. 10-2024-0109706, filed Aug. 16, 2024, the entire contents of which is incorporated herein for all purposes by this reference.

### BACKGROUND OF THE INVENTION

### Field of the Invention

The present invention relates to a motor stator, and more particularly, to a motor stator that facilitates the insertion and fixation of coil conductors.

### Description of the Related Art

The existing motor core structures commonly used for electric vehicles include two types, the hairpin stator and the continuous hairpin stator. Of the two types, the hairpin stator forms windings by inserting shaped copper wire into the stator slots, whereas the continuous hairpin stator uses ring-shaped copper wire inserted into the slots and welded to create an integrated winding, with this continuous design offering advantages over the traditional hairpin stator, including weight reduction, miniaturization, and cost savings, by eliminating the twisting process needed for circuit design and removing the welds at the copper wire ends.

However, unlike traditional hairpin stators where the coil pattern is inserted from top to bottom, the continuous hairpin stator requires insertion from the inside of the core to the outside, as the continuously formed coil pattern is inserted into the core, resulting in the elimination of the ‘shoe’ structure of the slot opening, as shown in FIG. 1. The ‘shoe’ structure of the stator not only serves to improve electromagnetic efficiency but also prevents the inserted hairpin conductors from shifting inward within the slot, while physically securing the hairpin conductors to enhance NVH (Noise, Vibration, and Harshness) characteristics. In other words, when the slot is open without the shoe structure, a wedge made of the same material as the original insulating material must be added to prevent the hairpin conductors from shifting, resulting in additional costs for the insertion process and quality control to inspect the wedge's displacement and proper insertion. Additionally, even with the use of the wedge to prevent conductor displacement, the issue of NVH characteristics remains unresolved.

### DOCUMENTS OF RELATED ART

(Patent Document 1) Korean Patent Registration No. 10-2497011 “Stator structure of hairpin wound motor”

### SUMMARY OF THE INVENTION

The present invention has been conceived to solve the above problems, and it is an object of the present invention to provide a motor stator capable of improving NVH characteristics and reducing costs compared to the prior art by eliminating the need for a wedge through the application of a shoe structure integrally formed at the end of an open slot and pressed inward only during hairpin insertion, which not only facilitates the insertion of conductors, including continuous hairpin conductors, but also limits conductor displacement and movement.

It is another object of the present invention to provide a motor stator capable of being configured to meet desired specifications, taking into account electromagnetic efficiency, conductor displacement force, and the ease of conductor insertion, through segmentation into multiple sections along the axial direction, with some segments applying the shoe structure and others not.

In order to accomplish the above objects, a motor stator including a coil conductor incorporating multiple coil strands according to an embodiment of the present invention includes at least one first plate including a central hole through which a motor rotor is inserted and slots extending radially outward from the motor, one side of which communicates with the central hole, the slots accommodating the multiple coil strands, and at least one second plate including a central hole and slots perforated to be identical in shape and position to the first plate, and a shoe protruding in the circumferential direction from one end of the slot, forming a boundary between the slot and the central hole, and supporting the position of the coil strands, wherein the first and second plates are stacked in the axial direction of the motor.

In addition, the second plate further includes a shoe protruding in the circumferential direction from the end of the slot, and a recess formed inwardly in the circumferential direction of the motor from an end wall of the slot.

In addition, the recess has a radial depth equal to or greater than the protrusion length of the shoe.

In addition, the shoe is formed in a hook shape with a pointed end.

In addition, the shoe is formed with a curved surface having a predetermined curvature at the end thereof.

In addition, the second plate is stacked in two or more pieces, and at least two of the shoes on the second plates have different shapes.

In addition, the first plate and the second plate are alternately stacked, with at least one of each and an equal number, along the axial direction of the motor.

In addition, the first plate and the second plate are alternately stacked, with at least one of each in different numbers, along the axial direction of the motor.

In addition, the first plate and the second plate are stacked each at least one in number to form a plate assembly, and at least one plate assembly is stacked along the axial direction, the at least one assembly including i second plates stacked with one surface in contact with each other, and first plates stacked on both sides of the i second plates in j and k pieces, respectively, where i, j, and k are predetermined natural numbers.

In addition, the first plate and the second plate are stacked each at least one in number to form a plate assembly, and at least one plate assembly is stacked along the axial direction, the at least one plate assembly including n first plates stacked with one surface in contact with each other, and second plates stacked on both sides of the n first plates in m and p pieces, respectively, where n, m, and p are predetermined natural numbers.

### BRIEF DESCRIPTION OF THE DRAWINGS

FIG. 1 is a schematic diagram illustrating a slot of a conventional stator to which a coil conductor, including a continuous hairpin, is applied.

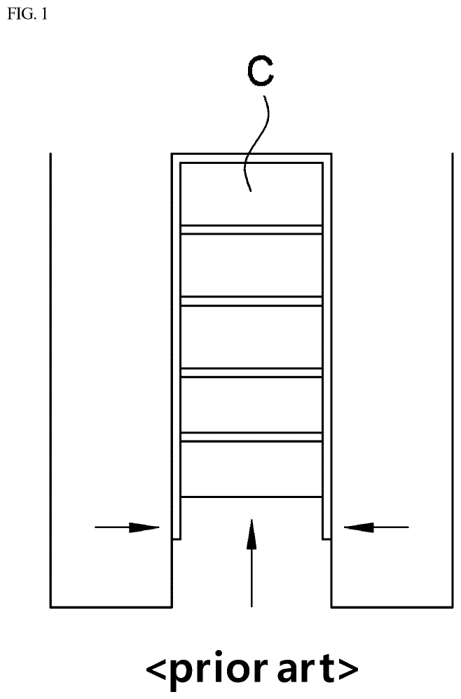

FIG. 2 is a perspective view illustrating a motor stator according to the present invention;

FIG. 3 is a partial plan view illustrating a first plate of the present invention;

FIG. 4 is a partial plan view illustrating a second plate of the motor stator according to the first embodiment of the present invention;

FIG. 5 is a partial perspective view illustrating the deformation of a shoe during coil conductor insertion in the motor stator according to the first embodiment of the present invention;

FIG. 6 is a partial plan view illustrating the deformation of a shoe during coil conductor insertion in the motor stator according to the first embodiment of the present invention;

FIG. 7 is a schematic diagram illustrating a method of inserting a coil conductor in the motor stator according to the first embodiment of the present invention;

FIG. 8 is a schematic diagram illustrating the spring-back force generated between the coil conductor and the shoe in the motor stator according to the first embodiment of the present invention;

FIG. 9 is a partial plan view illustrating a second plate of the motor stator according to the second embodiment of the present invention;

FIG. 10 is a schematic diagram illustrating a method of inserting a coil conductor in the motor stator according to the second embodiment of the present invention;

FIG. 11 is a schematic diagram illustrating the restoring force generated between the coil conductor and the shoe in the motor stator according to the second embodiment of the present invention; and

FIG. 12 is a partial perspective view illustrating the arrangement of the first plate and the second plate in the motor stator according to the first embodiment of the present invention.

### DETAILED DESCRIPTION OF THE INVENTION

In the following, the technical aspects of the present invention will be described in more detail with reference to the accompanying drawings. Prior to this, the terms and words used in the following specification and claims should not be construed in a limited sense to their usual or dictionary meanings but should be interpreted according to the meanings and concepts that conform to the technical ideas of the present invention, based on the principle that the inventor can appropriately define the terms to best describe their invention.

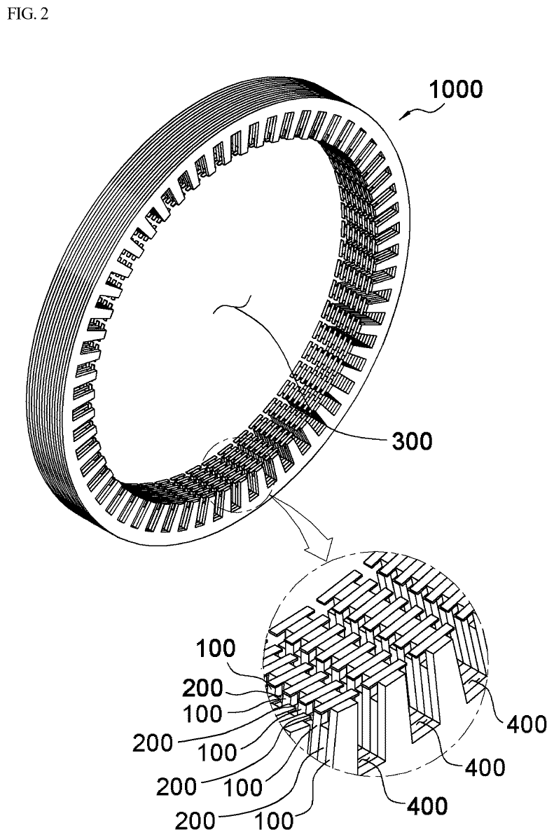

Hereinafter, the basic configuration of the motor stator 1000 of the present invention is described with reference to FIG. 2.

The motor stator 1000 of the present invention may include a coil conductor C inside, which is composed of a plurality of coil strands. As shown in FIG. 2, the motor stator 1000 of the present invention includes first and second plates 100 and 200, stacked in the axial direction to form a cylindrical shape. Here, the coil conductor C may include a plurality of continuous hairpins that are continuously formed in a ring shape.

In detail, the motor stator 1000 of the present invention incorporates a shoe structure 210 that is pressed inward only during the insertion of the coil conductor C into the second plate 200, thereby not only facilitating the insertion of the coil conductor C, including continuous hairpins, but also limiting the displacement and movement of the coil conductor C to enhance NVH characteristics. Additionally, eliminating the wedge, which supports the coil conductor C in the conventional structure, simplifies the manufacturing process and reduces costs.

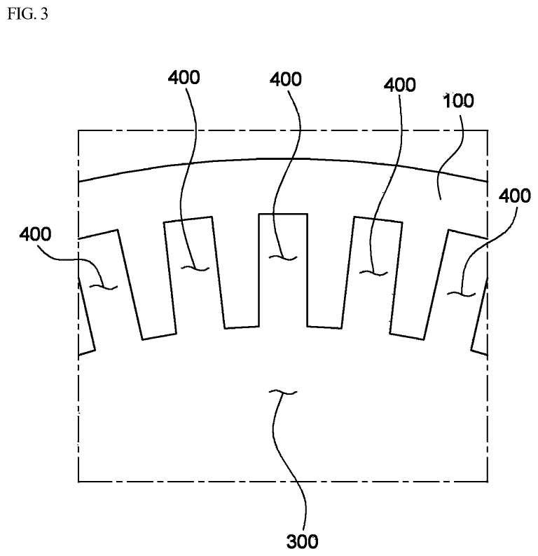

Hereinafter, a description is made of the motor stator according to the first embodiment of the present invention with reference to FIGS. 3 to 8.

As shown in FIG. 3, the first plate 100 may include a central hole 300 for the insertion of the motor rotor and slots 400 extending radially from the motor, communicating with the central hole 300 to accommodate a plurality of coil strands. The first plates 100 may be provided in two or more pieces and stacked in the axial direction of the motor. The first plate 100 is formed such that the slot 400 and central hole 300 are completely open.

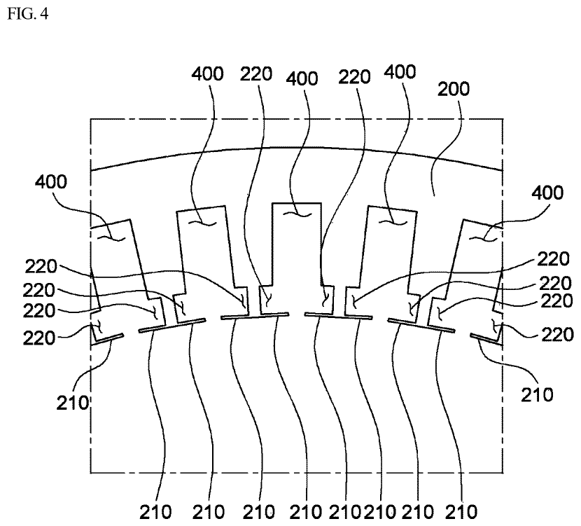

Additionally, as shown in FIG. 4, the second plate 200 may be perforated to form a central hole 300 and a slot 400 in the same shape and at the same position as in the first plate 100, with a shoe 210 protruding in the circumferential direction from one end of the slot 400 and positioned at the boundary between the slot 400 and the central hole 300 to support the position of the coil strands. The positions and shapes of the central hole 300 and slot 400 formed in the first plate 100 and the second plate 200 are identical, allowing for smooth engagement between the motor rotor, coil conductor C, and the motor stator 1000 of the present invention.

In addition to the shoe 210 protruding in the circumferential direction from the end of the slot 400, the second plate 200 may also include a recess 220 concavely formed inward in the circumferential direction of the motor from the end wall of the slot 400. In other words, the end of the slot 400 in the second plate 200 may be formed in an “I” shape. The shoe 210 may form with the same axial thickness as the second plate 200 and may protrude in a cuboid shape. Additionally, the shoe 210 may be formed thin enough to bend easily with a small force.

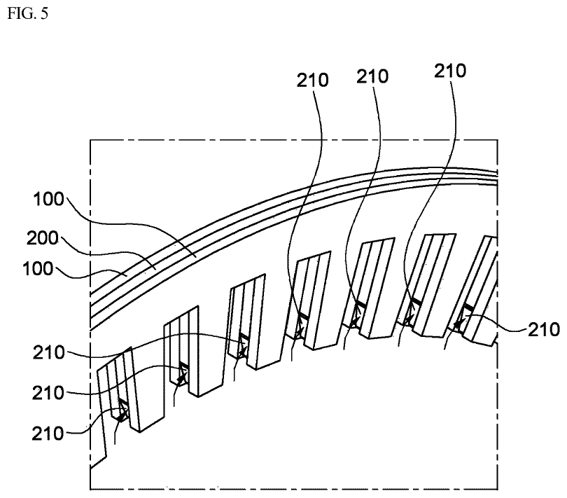

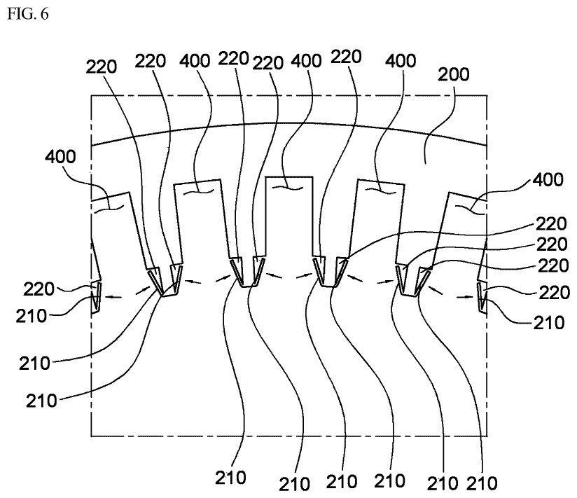

The recess 220 may be concavely formed in a cuboid shape and, when the first plate 100 and second plate 200 are stacked to form a cylindrical shape, create a predetermined space between them. In this case, the radial depth of the recess 220 may be equal to or greater than the protrusion length of the shoe 210. Accordingly, as shown in FIGS. 5 and 6, the shoe 210 of the second plate 200 may be fully inserted into the recess 220 without protruding outward when an external force is applied.

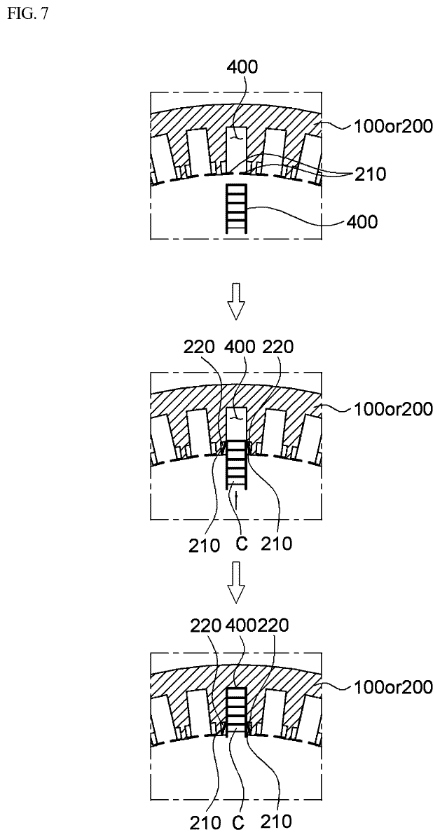

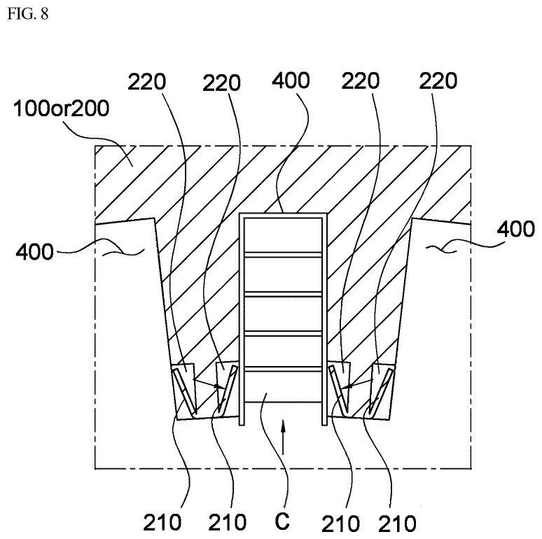

As shown in FIG. 7, this allows the coil conductor C to be inserted and fixed into the motor stator 1000 of the present invention. In more detail, as shown in the second figure, when the coil conductor C is inserted into the slot 400 of the motor stator 1000, the shoe 210 protruding from the second plate 200 may be received into the recess 220, and after the coil conductor C is accommodated, as shown in the third figure, force may be applied to the side of the coil conductor C facing the wall of the slot 400. That is, as shown in FIG. 8, the shoe 210 pressed during the insertion of the coil conductor C may attempt to return to its original state, and its spring-back force may be used to press against the side of the coil conductor C. This ensures that the coil conductor C is securely fixed and will not be removed.

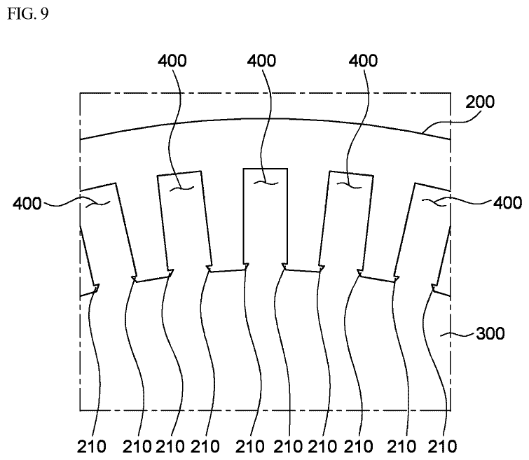

Hereinafter, a description is made of the motor stator 1000 according to the second embodiment of the present invention with reference to FIGS. 9 to 11.

As shown in FIG. 9, the second plate 200 may include a shoe 210 protruding in the circumferential direction from the end of the slot 400, and the shoe 210 may be formed in a hook shape with a pointed end. More specifically, the surface of the shoe 210 that comes into contact with the coil conductor C during insertion may be inclined at a predetermined angle relative to the radial direction, while the surface of the shoe 210 facing the inside of the slot 400 may be flat in the circumferential direction. Additionally, the shoe 210 may be formed thin enough to bend easily with a small force. In an alternative embodiment, the shoe 210 may be made of an elastic material different from that of the second plate 200.

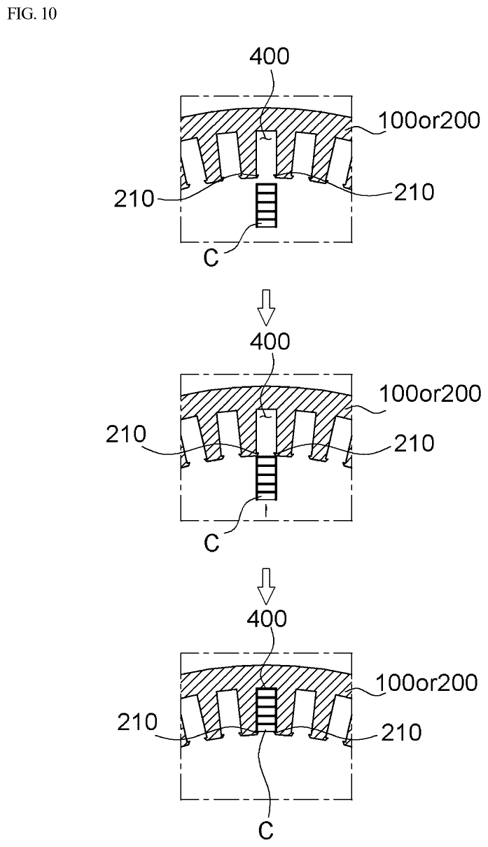

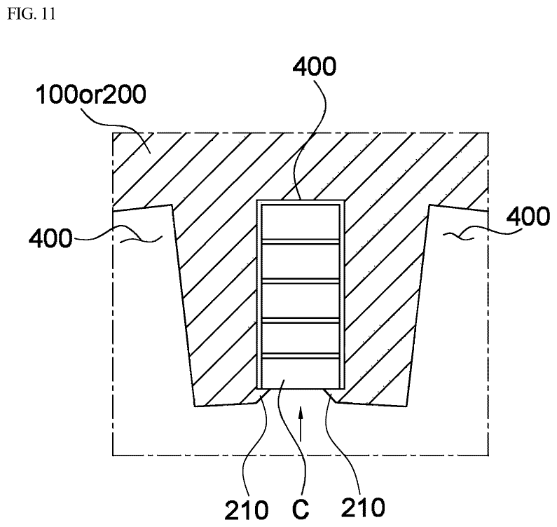

Accordingly, as shown in FIG. 10, the coil conductor C may be inserted and fixed into the motor stator 1000 of the present invention. More specifically, as shown in the second figure, when the coil conductor C is inserted into the slot 400, the inclined surface in contact with the coil conductor C allows the shoe 210 to bend easily, undergoing elastic deformation or partial plastic deformation. Subsequently, as shown in the third figure, after the coil conductor C is inserted into the slot 400, the elastically deformed shoe 210 may recover and return to its original position, or when partially plastically deformed, it may be restored to its original position by spring-back force. Finally, as shown in FIG. 11, the coil conductor C may be securely supported through the flat surface formed in the circumferential direction to prevent it from being detached.

In the second embodiment, the shoe 210 of the motor stator 1000 may be formed with a curved surface at its end having a predetermined curvature. This may reduce the friction between the coil conductor C and the shoe 210, allowing the shoe 210 to bend smoothly and deform when the coil conductor C is inserted.

Furthermore, the second plate 200 may be stacked in two or more pieces, and at least two of the second plates 200 may have different shoe 210 shapes. More specifically, among the second plates 200 constituting the motor stator 1000, one may have the shoe 210 formed in the shape according to the first embodiment, and another may have the shoe 210 formed in the shape according to the second embodiment. This may allow adjustment of the force applied by the shoe 210 and the location where the spring-back force or restoring force from the elastic deformation of the shoe 210 acts at each axial position of the coil conductor C, leading to more stable fixation of the coil conductor C in the proper position.

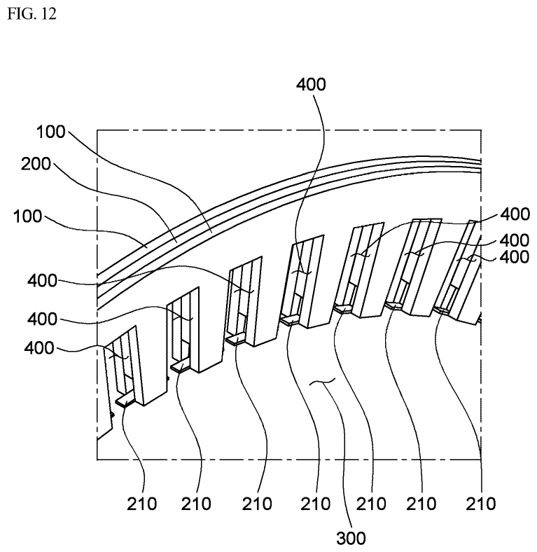

Hereinafter, a detailed description is made of the arrangement of the first plate 100 and second plate 200 according to an embodiment of the present invention with reference to FIG. 12.

The arrangement of the first plate 100 and second plate 200 may be implemented in various embodiments, allowing the motor stator 1000 to be configured with desired specifications by considering factors such as electromagnetic efficiency, the detachment force of the coil conductor C, and the ease of insertion of the coil conductor C. These embodiments are described in more detail below.

As shown in FIG. 12, the first plate 100 and second plate 200 may be stacked alternately, with at least one of each and an equal number, along the axial direction of the motor. This allows the spring-back force or restoring force from the elastic deformation of the shoe 210 to be applied uniformly to the sides of the coil conductor C, thereby more stably supporting the position of the coil conductor C. The number of alternately stacked first and second plates 100 and 200 may be determined by considering factors such as magnetic efficiency, the detachment force of the coil conductor C, and the ease of insertion of the coil conductor C.

Alternatively, the first plate 100 and the second plate 200 may be alternately stacked along the axial direction of the motor with at least one of each in varying numbers, allowing for a higher density of the second plates 200 to be positioned where greater force is needed to support the coil conductor C, when the coil conductor C has a non-uniform specific shape along the axial direction or when greater support is required at a particular axial location of the coil conductor C.

Alternatively, the motor stator 1000 of the present invention may include one or more plate assemblies stacked in the axial direction, each plate assembly composed of at least one first plate 100 and at least one second plate 200 stacked. In this case, the plate assembly may include i second plates 200 stacked with one surface in contact with each other, and first plates 100 stacked on both sides of the i second plates 200 in j and k pieces, respectively. By providing one or more first plates 100 on both sides of the i second plates 200, a space for the shoe 210 to avoid may be created between the first plate 100 and the recess 220 (in the motor stator 1000 according to the first embodiment), and by having the first plate 100, rather than the second plate 200, at both ends of the motor stator 1000, the overall structural stability can be enhanced.

Alternatively, the plate assembly may include n first plates 100 stacked with one surface in contact with each other, and second plates 200 stacked on both sides of the n first plates 100, with m and p second plates 200 stacked on each side, respectively. By providing one or more second plates 200 on both sides of the n first plates 100, a space for the shoe 210 to avoid may be provided between the first plate 100 and the recess 220 (in the motor stator 1000 according to the first embodiment), and by having the second plates 200 provided at both ends of the motor stator 1000, the deformation and load application of the shoe 210 during the insertion of the coil conductor C can be properly checked.

The motor stator of the present invention is advantageous in terms of improving NVH characteristics and reducing costs compared to the prior art by eliminating the need for a wedge through the application of a shoe structure integrally formed at the end of an open slot and pressed inward only during hairpin insertion, which not only facilitates the insertion of conductors, including continuous hairpin conductors, but also limits conductor displacement and movement.

The motor stator of the present invention is also advantageous in term of being configurable to meet desired specifications, taking into account electromagnetic efficiency, conductor displacement force, and the ease of conductor insertion, through segmentation into multiple sections along the axial direction, with some sections applying the shoe structure and others not.

The technical concept of the present invention should not be interpreted solely based on the above-described embodiments. It should be understood that various modifications and changes are possible within the scope of the claims without departing from the essence of the invention claimed in the claims. Therefore, such improvements and changes fall within the scope of protection of the present invention, as long as they are obvious to those skilled in the art.

### DESCRIPTION OF REFERENCE NUMERALS

1000: motor stator
100: first plate
200: second plate
210: shoe
220: recess
300: central hole
400: slot
C: coil conductor

What is claimed is:

1. A motor stator including a coil conductor incorporating multiple coil strands, the motor stator comprising:
at least one first plate comprising a central hole through which a motor rotor is inserted and slots extending radially outward from the motor, one side of which communicates with the central hole, the slots accommodating the multiple coil strands; and
at least one second plate comprising a central hole and slots perforated to be identical in shape and position to the first plate, and a shoe protruding in a circumferential direction from one end of the slot, forming a boundary between the slot and the central hole, and supporting the position of the coil strands,
wherein the first and second plates are stacked along an axial direction of the motor.

2. The motor stator of claim 1, wherein the second plate further comprises:
the shoe protruding in the circumferential direction from the end of the slot; and
a recess extending inwardly in the circumferential direction of the motor from an end wall of the slot.

3. The motor stator of claim 2, wherein the recess has a radial depth equal to or greater than a protrusion length of the shoe.

4. The motor stator of claim 1, wherein the shoe has a hook shaped structure with a pointed end.

5. The motor stator of claim 1, wherein the shoe includes a curved surface having a predetermined curvature at an end thereof.

6. The motor stator of claim 1, wherein the second plate is stacked in two or more pieces, and at least two of the shoes on the second plates have different shapes.

7. The motor stator of claim 1, wherein the first plate and the second plate are alternately stacked, with at least one of each and an equal number, along the axial direction of the motor.

8. The motor stator of claim 1, wherein the first plate and the second plate are alternately stacked, with at least one of each in different numbers, along the axial direction of the motor.

9. The motor stator of claim 8, wherein the first plate and the second plate are each stacked in at least one layer to form a plate assembly, and at least one plate assembly is stacked along the axial direction, the at least one assembly comprising i second plates stacked with one surface in contact with each other, and first plates stacked on both sides of the i second plates in j and k pieces, respectively, where i, j, and k are predetermined natural numbers.

10. The motor stator of claim 1, wherein the first plate and the second plate are each stacked in at least one layer to form a plate assembly, and at least one plate assembly is stacked along the axial direction, the at least one plate assembly comprising n first plates stacked with one surface in contact with each other, and second plates stacked on both sides of the n first plates in m and p pieces, respectively, where n, m, and p are predetermined natural numbers.
